(19) United States
(12) Patent Application Publication
(10) Pub. No.: US 2024/0301961 A1
(43) Pub. Date: Sep. 12, 2024

(54) KINETIC HINGE FOR A PRESSURE RELIEF DEVICE

(71) Applicant: BS&B INNOVATIONS LIMITED, Limerick (IE)

(72) Inventors: Brian ENGMAN, Muskogee, OK (US); Geoffrey BRAZIER, Woodbury, MN (US)

(73) Assignee: BS&B INNOVATIONS LIMITED, Limerick (IE)

(21) Appl. No.: 18/551,139

(22) PCT Filed: Mar. 16, 2022
(86) PCT No.: PCT/IB2022/052408

§ 371 Date: Sep. 18, 2023

Related U.S. Application Data
(60) Provisional application No. 63/162,143, filed on Mar. 17, 2021.

(51) Int. Cl. F16K 17/16

(52) U.S. Cl. CPC F16K 17/1613

(57) ABSTRACT

The disclosure relates to a kinetic hinge for a pressure relief device, such as a rupture disk. In one embodiment, the kinetic hinge may extend from an inner periphery of a flange ring, into a central fluid flow path. The hinge may be configured to deform in response to an activation of the rupture disk, thereby allowing the hinge to move radially out of the central fluid flow path. In other embodiments, a kinetic hinge may include a retaining element, reinforcing element, stiffening element, pre-weakened area, perforation, or other features configured to control or influence the manner in which the kinetic hinge may deform.

### FIELD OF THE DISCLOSURE

This disclosure generally relates to a hinge for a pressure relief device. More specifically, this disclosure relates to a kinetic hinge providing improved performance for a pressure relief device such as a rupture disk or explosion vent.

### BACKGROUND

Pressure relief devices are commonly used as safety devices in systems containing pressurized fluids in gas or liquid form, or in contained systems containing volatile (e.g., flammable) conditions or combustible dust conditions that may lead to a potentially dangerous increase in pressure. A pressure relief device will vent fluid or products of particulate combustion from a system when the pressure in the system reaches a predetermined level-usually before it reaches an unsafe level. One category of pressure relief device-a membrane pressure relief device-includes, e.g., rupture disks and burst panels, also known as explosion vents.

A rupture disk is used to release pressure from a pressurized system in response to a potentially dangerous overpressure situation. Generally, a rupture disk has a flange that is sealed between a pair of support members, or safety heads, forming a pressure relief assembly. The pressure relief assembly may then be clamped or otherwise sealingly disposed between a pair of conventional pipe flanges or between a pair of threaded fittings, or attached to one such threaded fitting, in the pressurized system. A first pipe conducts pressurized fluid to one side of the pressure relief assembly, and a second pipe provides an outlet to a safety reservoir or may be open to the environment. The support members include central openings that expose a portion of the rupture disk to the pressurized fluid in the system. The exposed portion of the rupture disk will rupture when the pressure of the fluid reaches a predetermined differential pressure between the inlet and outlet sides. The ruptured disk creates a vent path that allows fluid or products of particulate combustion to escape through the outlet to reduce the pressure in the system.

The predetermined pressure differential at which a rupture disk will rupture is known as the “burst pressure.” The burst pressure for which a rupture disk is rated is known as the “nominal burst pressure.” The burst pressure may be set by way of the rupture disk's physical parameters, such as material thickness and dome height (also known as “crown height”). The burst pressure also may be set using various physical features, such as indentations.

A rupture disk typically has a dome-shaped, rounded-shaped, conical shape, truncated conical shape, or other generally curved rupturable portion and can be either forward-acting or reverse-acting. A forward-acting rupture disk is positioned with the concave side of the rupturable portion exposed to the pressurized system, placing the disk under tension. Thus, when an over-pressure condition is reached—i.e., when the system pressure exceeds a safe or desirable level—the rupture disk may release pressure by bursting outward. Conversely, a reverse-acting rupture disk (also known as a reverse buckling rupture disk) is positioned with its convex side exposed to the pressurized system, placing the material of the disk under compression. Thus, when an over-pressure condition is reached, the rupture disk may buckle and reverse—i.e., invert—and tear away to vent pressurized fluid. Substantially flat rupture disks also burst due to tensile material failure when the intended burst pressure is applied.

A reverse buckling rupture disk may rupture by itself upon reversal. Alternatively, additional features may be provided to facilitate rupture. For example, a cutting structure or stress concentration point may contact the reverse buckling rupture disk on reversal, ensuring that rupture occurs. Exemplary cutting structures include one or more blades (e.g., a four-part blade like that provided by BS&B Safety Systems as part of the commercially available RB-90™ reverse buckling disk, or a tri-shaped three-part blade like that provided by BS&B Safety Systems as part of the commercially available DKB VAC-SAF™ rupture disk) and circular toothed rings (e.g., like that provided by BS&B Safety Systems as part of the commercially available JRS™ rupture disk). Other exemplary cutting structures may be positioned along the periphery of a rupturable portion. Still other exemplary cutting structures may be positioned in an X-shape, Y-shape, or irregular Y-shape designed to engage with the rupturable portion upon reversal.

Physical features, such as score lines and shear lines (and other areas of weakness, also known as lines of weakness), may be used to facilitate opening of a rupture disk and control the opening pattern of a rupture disk. In a reverse buckling disk, for example, the disk will tear along a score line when the disk is reversing. A score or shear line may be used in combination with a stress concentration point or cutting member. Selected portions of the disk may be left unscored, acting as a hinge area, to prevent the disk from fragmenting upon bursting and the fragments from the disk escaping along with fluid from the pressurized system. A central portion of the disk that is partially torn away from the rest of the disk may be referred to as a “petal.”

Fragmentation may also be controlled through the use of a hinge located downstream of a rupture disk. The hinge may interact with the petal of an activated rupture disk, capture the petal as it rotates to open, control the location at which the petal bends, absorb kinetic energy of the petal, or provide other benefits. A hinge may be a peripheral hinge, positioned at the periphery of the rupture disk (e.g., adjacent to an unscored area of the disk). Alternatively, a hinge may extend into, or otherwise be positioned near, central portions of the rupture disk. Examples of known hinges used with rupture disks include hinges used with the following products of BS&B Safety Systems:
JRS™ non-scored, reverse buckling rupture disk provided with a toothed ring (to provide cutting) and a peripheral hinge to retain the petal after activation;
RLS™ circular-scored, reverse buckling rupture disk provided with an integral downstream Y-shaped hinge welded to the rupture disk dome, particularly suited for high-pressure applications;
SKr™ circular scored, reverse buckling rupture disk provided with a complex, 3-dimensional design configured to capture and absorb kinetic energy of the petal;
LPS™ circular scored, reverse buckling rupture disk with a flat outlet-side hinge particularly suited for low-pressure applications;
CSR™/CSI™ circular scored, reverse buckling rupture disks with a hinge integrated into the outlet side of the safety head to manage fragmentation after activation;
FRX™ circular scored, reverse buckling rupture disk with a diving-board-like hinge, which is designed to deform by bending as the rupture disk activates, thereby absorbing kinetic energy and managing fragmentation; and
GCR™ circular scored, reverse buckling rupture disk with a 3-dimensional, energy-absorbing hinge.

A typical rupture disk hinge partially obstructs the flow path through an activated rupture disk, thereby impeding the flow of escaping fluid. Such obstruction is undesirable, because it may decrease the rate at which pressure may be vented from a dangerously over-pressured system. Accordingly, there is a need to improve the opening quality of a rupture disk and hinge, resulting in lower flow resistance values (Krg for gas, Krl for liquid). The ASME code sets a default flow resistance value of 2.4, although rupture disk manufacturers may seek to design products with lower flow resistance.

In some applications, it may be desirable to provide a rupture disk with a non-corrosive liner, such as a fluorocarbon film liner. Providing a liner, however, may further impede the opening of an activated rupture disk. Accordingly, there is a need to improve the opening characteristics of a lined rupture disk, particularly when the lined rupture disk is used in conjunction with a flow-obstructing hinge. The present disclosure provides these and other advantages, and overcomes other obstacles as described herein.

### BRIEF DESCRIPTION OF THE DRAWINGS

The accompanying drawings, which are incorporated in and constitute a part of this specification, illustrate several embodiments and together with the description, serve to explain principles of the disclosure.

FIG. 1 illustrates an embodiment of a kinetic hinge provided with a perforated or intermittently cut root portion;

FIG. 2 illustrates another embodiment of a kinetic hinge provided with a perforated or intermittently cut root portion, in combination with a support member/rupture disk holder;

FIG. 3 illustrates the embodiment of FIG. 2, with the kinetic hinge in an open (post-activation) configuration, with a leading edge in contact with the inner surface of an outlet safety head;

FIG. 4 illustrates another embodiment of a kinetic hinge after activation of a rupture disk;

FIG. 5 illustrates an embodiment of a kinetic hinge provided with a perforated root portion;

FIG. 6 illustrates the embodiment of FIG. 5, together with a support member/rupture disk holder;

FIG. 7 illustrates the embodiment of FIG. 6 after activation, with the hinge in an “open” configuration;

FIG. 8 illustrates an embodiment of a kinetic hinge provided with a perforated root portion;

FIG. 9 illustrates the embodiment of FIG. 8, together with a support member/rupture disk holder;

FIG. 10 illustrates the embodiment of FIG. 9 after activation, with the hinge in an “open” configuration;

FIG. 11 illustrates an embodiment of a kinetic hinge provided with a perforated root portion;

FIG. 12 illustrates the embodiment of FIG. 11, together with a support member/rupture disk holder;

FIG. 13 illustrates the embodiment of FIG. 12 after activation, with the hinge in an “open” configuration;

FIG. 14 illustrates an embodiment of a kinetic hinge provided with a perforated root portion;

FIG. 15 illustrates the embodiment of FIG. 14, together with a support member/rupture disk holder;

FIG. 16 illustrates the embodiment of FIG. 15 after activation, with the hinge in an “open” configuration;

FIG. 17 illustrates another embodiment of a kinetic hinge;

FIG. 18 illustrates still another embodiment of a kinetic hinge;

FIG. 19 illustrates a further embodiment of a kinetic hinge; and

FIG. 20 illustrates another embodiment of a kinetic hinge.

### DESCRIPTION OF THE EMBODIMENTS

Reference will now be made in detail to the present exemplary embodiments, examples of which are illustrated in the accompanying drawings.

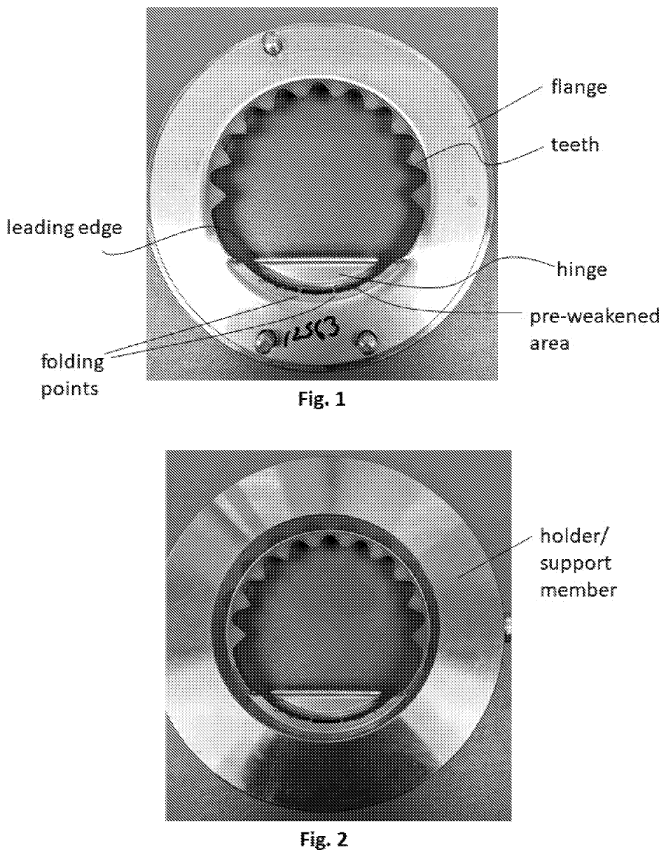

FIG. 1 illustrates one embodiment of the disclosure, in which a kinetic hinge device is provided with a flanged ring portion, a peripheral rupture disk hinge, and tooth elements. The kinetic hinge device of FIG. 1 is configured for use in piping systems having a 3-inch nominal size. The hinge includes a pre-weakened area at its root (or base), i.e., where the hinge meets the flanged ring portion. In the embodiment of FIG. 1, the pre-weakened area is provided by cutting through or perforating part(s) of the hinge root. Such cutting may be achieved, e.g., by laser cutting or a stamping operation or by wire electrical discharge machining (EDM) to remove material. In one embodiment, an existing static hinge device may be converted into a kinetic hinge by creating a pre-weakened area. The remaining, un-cut portion(s) of the hinge root form folding points configured to fold or bend upon activation of a rupture disk, while keeping the hinge attached to the flanged ring. Although the pre-weakened area of FIG. 1 is illustrated at the root of the hinge, the disclosure is not limited to that configuration. It is contemplated that a pre-weakened area may be provided, e.g., at the corners of a hinge or within the body of a hinge. Further, the disclosure is not limited to pre-weakened areas formed by perforation or cutting (e.g., mechanical cutting or laser cutting). In alternative embodiments, a pre-weakened area may be formed by scoring, shearing, stamping, ablation (laser, electrical arc, mechanical, or chemical ablation), or other suitable process. In addition, while FIG. 1 illustrates a pre-weakened area with cuts/perforations through the entire thickness of the hinge material, it is contemplated that a pre-weakened area may be created by thinning, weakening, material removal, or other process that does not cut/perforate through the hinge material.

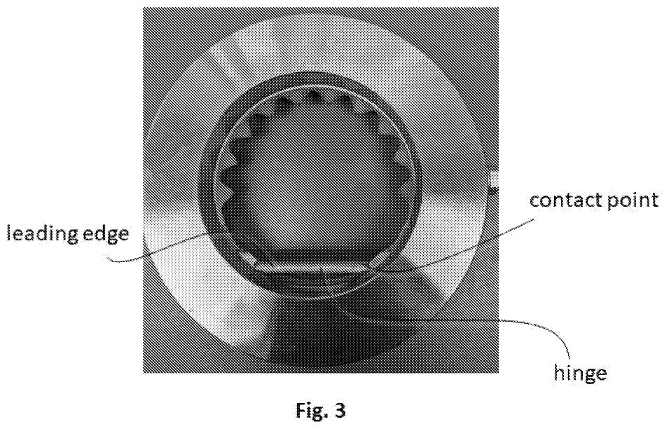

FIG. 2 illustrates the kinetic hinge device of FIG. 1 installed within a support member/rupture disk holder (or safety head). As illustrated, the ring-shaped rupture disk holder is configured to engage with the flange portion of the kinetic hinge device. Upon activation of a rupture disk (not shown), the rupture disk will be cut or torn along the tooth elements of the hinge device, creating a rupture disk petal. Escaping pressure will force the rupture disk petal to open out of the path of the escaping pressure. When the petal opens, it will contact the leading edge of the hinge (identified in FIG. 1). Unlike a conventional static rupture disk hinge, when a rupture disk petal contacts the leading edge of the disclosed kinetic hinge (FIG. 1 and FIG. 2), the kinetic hinge will deform (e.g., bend) along its root at the folding points illustrated in FIG. 1. The kinetic hinge will continue to deform until it comes into contact with the inner surface of the rupture disk support member, as illustrated in FIG. 3. In this manner, the kinetic hinge absorbs kinetic energy and moves substantially out of the path of fluid flow. Thus, the rupture disk may open more fully, significantly reducing the obstruction of the fluid flow path, while still preventing the rupture disk petal from fragmenting. As illustrated in FIG. 3, the leading edge of the hinge is configured to maintain its shape as a straight chord between two points on the inner surface of the support member, even after being forced into contact with the inner surface of the support member. That is, the hinge leading edge may be configured not to significantly bend or crumple. The straight-chord design may advantageously cause the rupture disk petal to bend around the leading edge of the hinge, thereby preventing petal fragmentation or tearing. Further, the length of the hinge leading edge may be designed to set the opening area of an activated rupture disk. In one embodiment, a manufacturer may design a series of kinetic hinges for different nominal size applications, while ensuring proportionate open areas and consistent flow performance in proportion to the nominal size.

In another embodiment, the leading edge of a kinetic hinge may be designed not to retain a straight-chord shape after activation. For example, the leading edge may be configured to conform to the contour of the outlet support member. Such a design may achieve even greater reductions in flow resistance, and may be achieved by optimizing the thickness and/or shape of the kinetic hinge in combination with the set pressure of the rupture disk.

Removing material to create a weakened area (such as illustrated in FIG. 1) may increase the risk that the hinge becomes fragmented during operation. To mitigate that risk, the amount of rotation of the kinetic hinge is limited by its interaction with the inner surface of the rupture disk holder (as illustrated in FIG. 3). As the kinetic hinge folds back, the rupture disk holder may provide a positive stop to prevent further movement of the hinge and prevent hinge fragmentation.

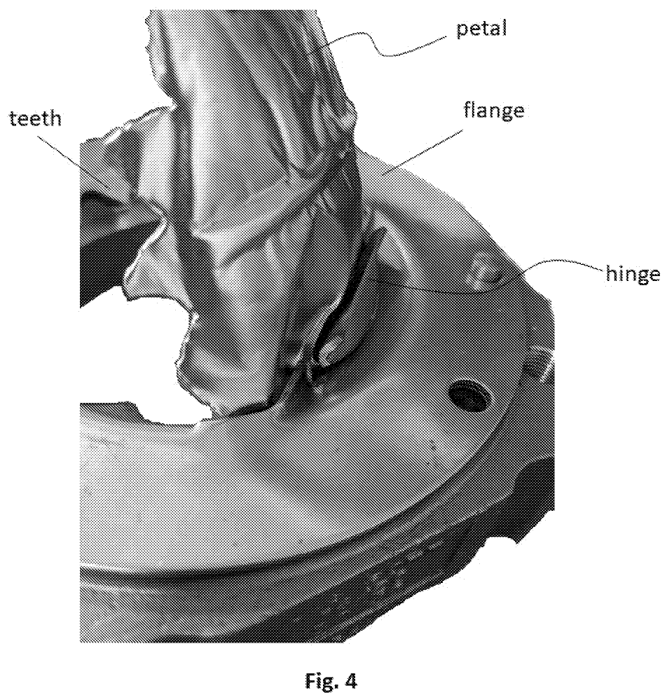

FIG. 4 illustrates a kinetic hinge (such as shown in FIG. 1) after activation of a rupture disk. As shown, the kinetic hinge has folded up, allowing the rupture disk petal to bend along the root of the kinetic hinge and creating a relatively large flow path for fluid to escape. Ordinarily, the opened kinetic hinge and rupture disk petal would be brought into contact with the inner surface of a rupture disk holder (or outlet safety head) installed on the downstream side of the disk and hinge. In FIG. 4, however, the rupture disk holder has been removed to provide a better view of the hinge and petal.

A kinetic hinge, such as depicted in FIGS. 1-4, may be particularly advantageous in applications using a lined/coated rupture disk (e.g., a rupture disk having a non-corrosive fluorocarbon liner). Ordinarily, a rupture disk liner may reduce the ability of a rupture disk petal to fold out of the path of an escaping fluid, thereby increasing the resistance to flow. The reduced opening of a lined rupture disk may be significantly counteracted through use of a kinetic hinge according to the disclosure.

As compared to a conventional, 3-inch-size static hinge, the disclosed 3-inch-size kinetic hinge has been observed to provide improved flow characteristics (Krg) using standard ASME PTC25 performance testing methodology. The standard 3-inch static hinge design exhibited a Krg average of 0.395. By comparison, the disclosed 3-inch kinetic hinge exhibited a significantly lower Krg average of 0.167.

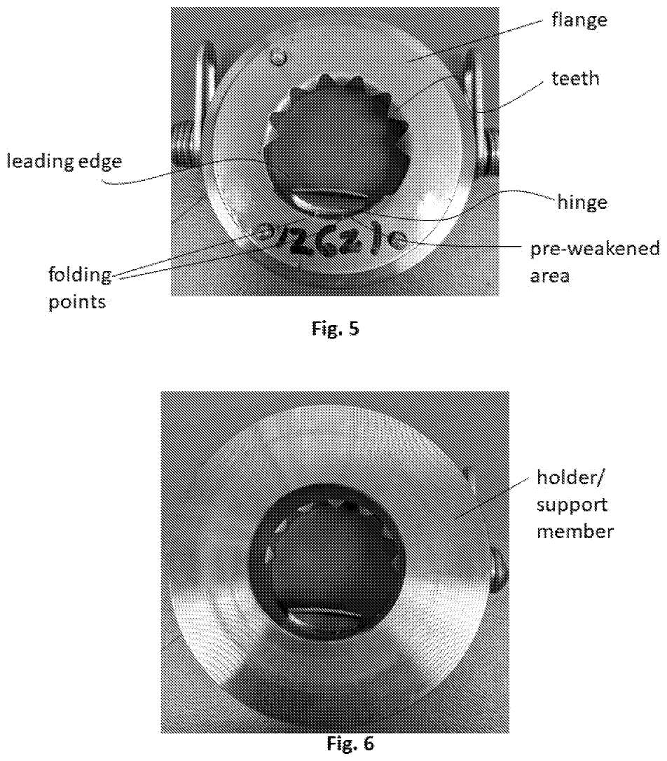

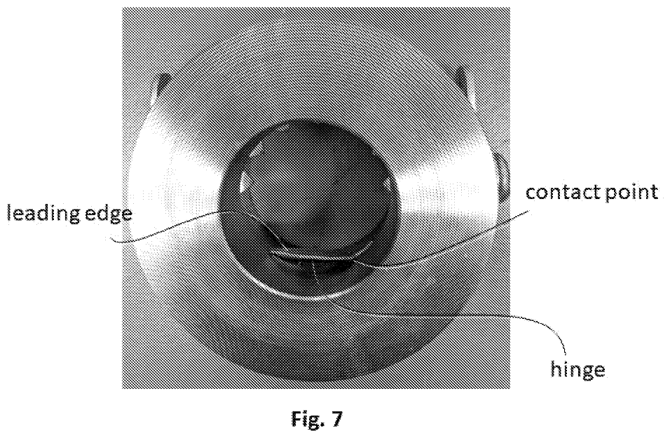

FIGS. 5-7 illustrate an embodiment of an improved 1-inch nominal size rupture disk hinge, including a kinetic hinge according to the present disclosure. As illustrated in FIG. 5, the kinetic hinge includes a pre-weakened area at its root, similar to the configuration illustrated in FIG. 1. FIG. 6 illustrates the kinetic hinge device of FIG. 5 installed within a rupture disk holder (or safety head), similar to the assembly illustrated in FIG. 2. Upon activation of a rupture disk (not shown), the rupture disk will be cut or torn along the tooth elements of the hinge device of FIGS. 5-6, creating a rupture disk petal. Escaping pressure will force the rupture disk petal to open out of the path of the escaping pressure, causing the kinetic hinge to bend along its root in a manner similar to that described in connection with FIG. 2. The kinetic hinge will continue to bend until it comes into contact with the inner surface of the rupture disk support member, as illustrated in FIG. 7.

As compared to a conventional, 1-inch-size static hinge, the disclosed 1-inch kinetic hinge has been observed to provide improved flow characteristics (Krg) using standard ASME PTC25 performance testing methodology. The conventional 1-inch static hinge design exhibited a Krg average of 0.361. By comparison, the disclosed 1-inch kinetic hinge exhibited a significantly lower Krg average of 0.251.

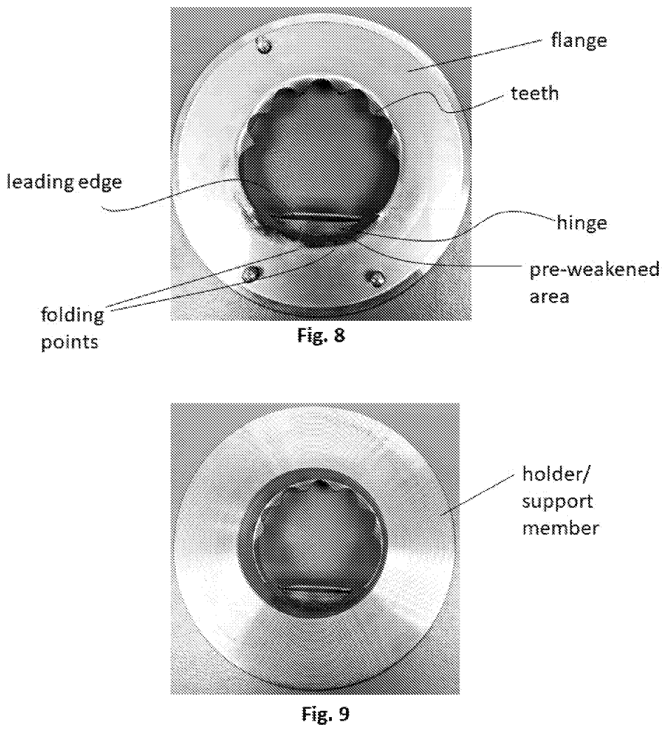

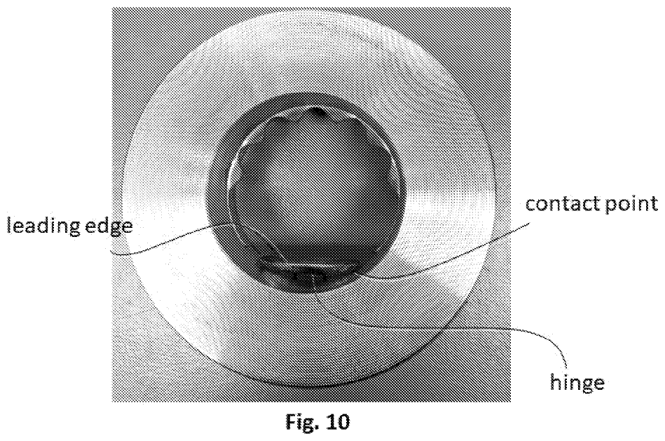

FIGS. 8-10 illustrate an embodiment of an improved 1.5-inch nominal size rupture disk hinge, including a kinetic hinge according to the present disclosure. As illustrated in FIG. 8, the kinetic hinge includes a pre-weakened area at its root, similar to the configuration illustrated in FIGS. 1 and 5. FIG. 9 illustrates the kinetic hinge device of FIG. 8 installed within a rupture disk holder (or safety head), similar to the assembly illustrated in FIGS. 2 and 6. Upon activation of a rupture disk (not shown), the rupture disk will be cut or torn along the tooth elements of the hinge device of FIGS. 8-9, creating a rupture disk petal. Escaping pressure will force the rupture disk petal to open out of the path of the escaping pressure, causing the kinetic hinge to bend along its root in a manner similar to that described in connection with FIG. 2. The kinetic hinge will continue to bend until it comes into contact with the inner surface of the rupture disk support member, as illustrated in FIG. 10.

As compared to a conventional, 1.5-inch-size static hinge, the disclosed 1.5-inch-size kinetic hinge has been observed to provide improved flow characteristics (Krg) using standard ASME PTC25 performance testing methodology. The conventional 1.5-inch static hinge design exhibited a Krg average of 0.314. By comparison, the disclosed 3-inch kinetic hinge exhibited a significantly lower Krg average of 0.265.

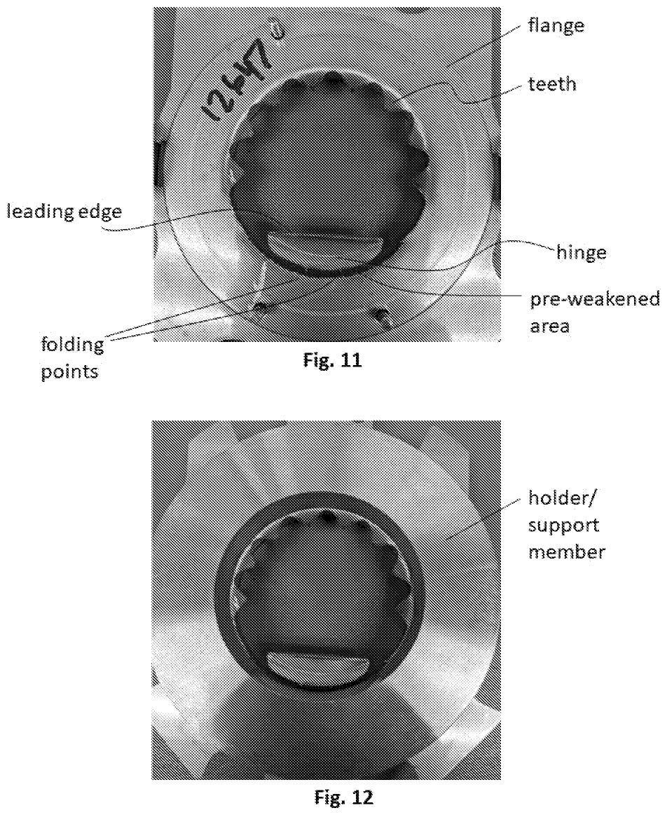

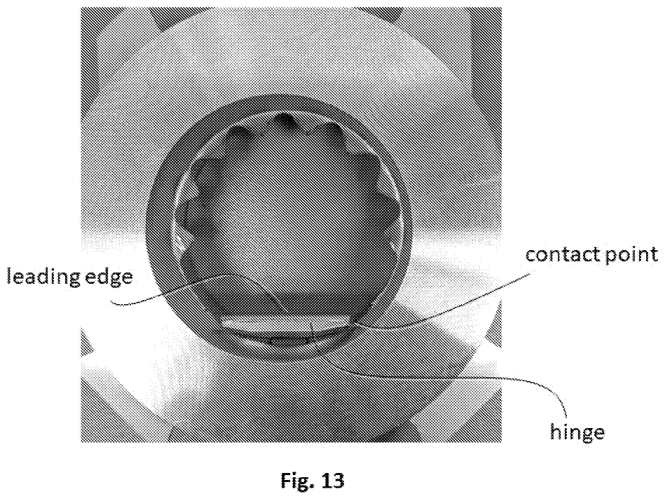

FIGS. 11-13 illustrate an embodiment of an improved 2-inch nominal size rupture disk hinge, including a kinetic hinge according to the present disclosure. As illustrated in FIG. 11, the kinetic hinge includes a pre-weakened area at its root, similar to the configuration illustrated in FIGS. 1, 5, and 8. FIG. 12 illustrates the kinetic hinge device of FIG. 11 installed within a rupture disk holder (or safety head), similar to the assembly illustrated in FIGS. 2, 6, and 9. Upon activation of a rupture disk (not shown), the rupture disk will be cut or torn along the tooth elements of the hinge device of FIGS. 11-13, creating a rupture disk petal. Escaping pressure will force the rupture disk petal to open out of the path of the escaping pressure, causing the kinetic hinge to bend along its root in a manner similar to that described in connection with FIG. 2. The kinetic hinge will continue to bend until it comes into contact with the inner surface of the rupture disk support member, as illustrated in FIG. 13.

As compared to a conventional, 2-inch-size static hinge, the disclosed 2-inch-size kinetic hinge has been observed to provide improved flow characteristics (Krg) using standard ASME PTC25 performance testing methodology. The conventional 2-inch static hinge design exhibited a Krg average of 0.301. By comparison, the disclosed 2-inch kinetic hinge exhibited a significantly lower Krg average of 0.201.

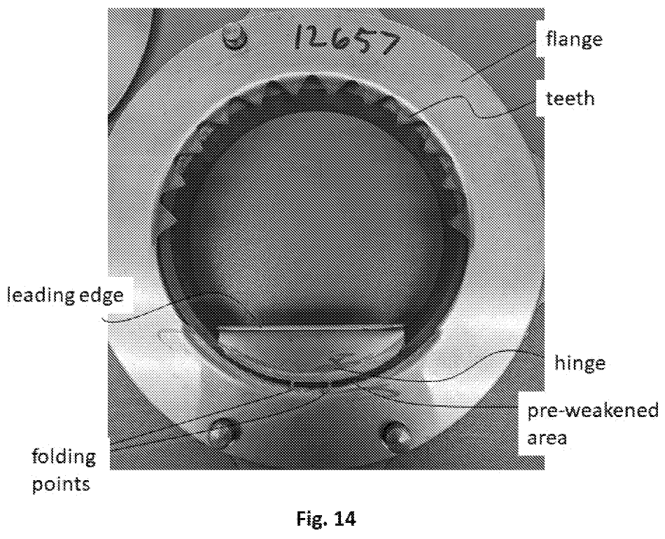

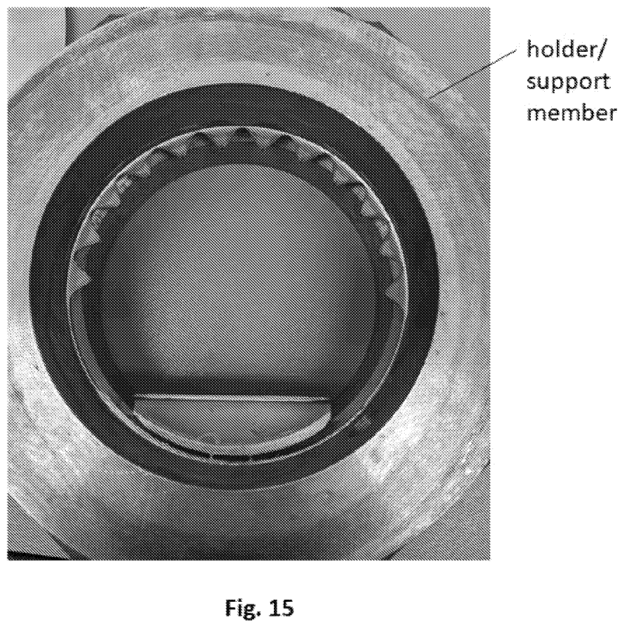

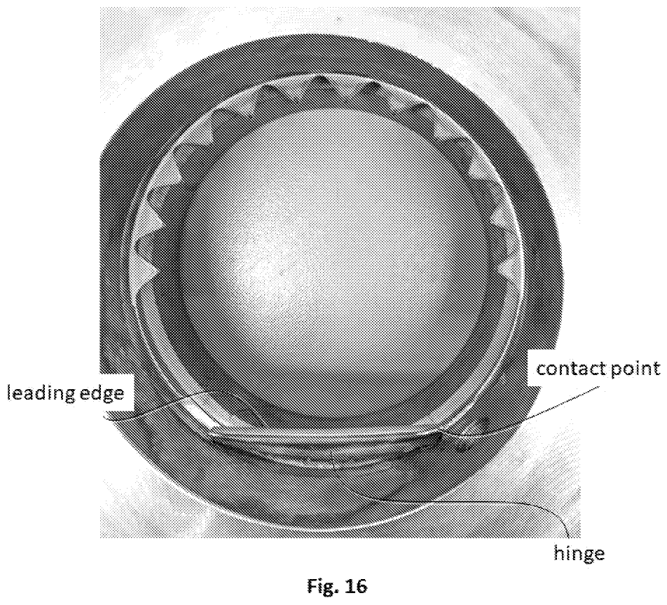

FIGS. 14-16 illustrate an embodiment of an improved 4-inch nominal size rupture disk hinge, including a kinetic hinge according to the present disclosure. As illustrated in FIG. 14, the kinetic hinge includes a pre-weakened area at its root, similar to the configuration illustrated in FIGS. 1, 5, 8, and 11. FIG. 15 illustrates the kinetic hinge device of FIG. 14 installed within a rupture disk holder (or safety head), similar to the assembly illustrated in FIGS. 2, 6, 9, and 12. Upon activation of a rupture disk (not shown), the rupture disk will be cut or torn along the tooth elements of the hinge device of FIGS. 14-15, creating a rupture disk petal. Escaping pressure will force the rupture disk petal to open out of the path of the escaping pressure, causing the kinetic hinge to bend along its root in a manner similar to that described in connection with FIG. 2. The kinetic hinge will continue to bend until it comes into contact with the inner surface of the rupture disk support member, as illustrated in FIG. 16.

As compared to a conventional, 4-inch-size static hinge, the disclosed 4-inch-size kinetic hinge has been observed to provide improved flow characteristics (Krg) using standard ASME PTC25 performance testing methodology. The conventional 4-inch static hinge design exhibited a Krg average of 0.415. By comparison, the disclosed 4-inch kinetic hinge exhibited a significantly lower Krg average of 0.183.

In one embodiment, a kinetic hinge according to the disclosure may be used to modify and improve the performance of any number of designs of scored and un-scored reverse-buckling rupture disks to provide improved flow characteristics, including BS&B Safety Systems rupture disks of the types designated JRS™, RLS™, SKr™, LPS™, CSR™, CSI™, FRX™, GCR™, and other types of rupture disks. It is further contemplated that the disclosed kinetic hinge may be used with tension-loaded or forward-acting rupture disks to improve flow characteristics and manage fragmentation.

The kinetic hinge illustrated in the foregoing figures is depicted with a single-petal-opening rupture disk. The disclosure is not limited to that implementation. In another embodiment, one or more kinetic hinges may be provided for use with a rupture disk that is configured to open via multiple petals. For example, a cross-scored rupture disk may create four petals when opening. A kinetic hinge may be provided for one or more of such petals, thereby providing improved flow characteristics while absorbing kinetic energy and improving fragmentation control.

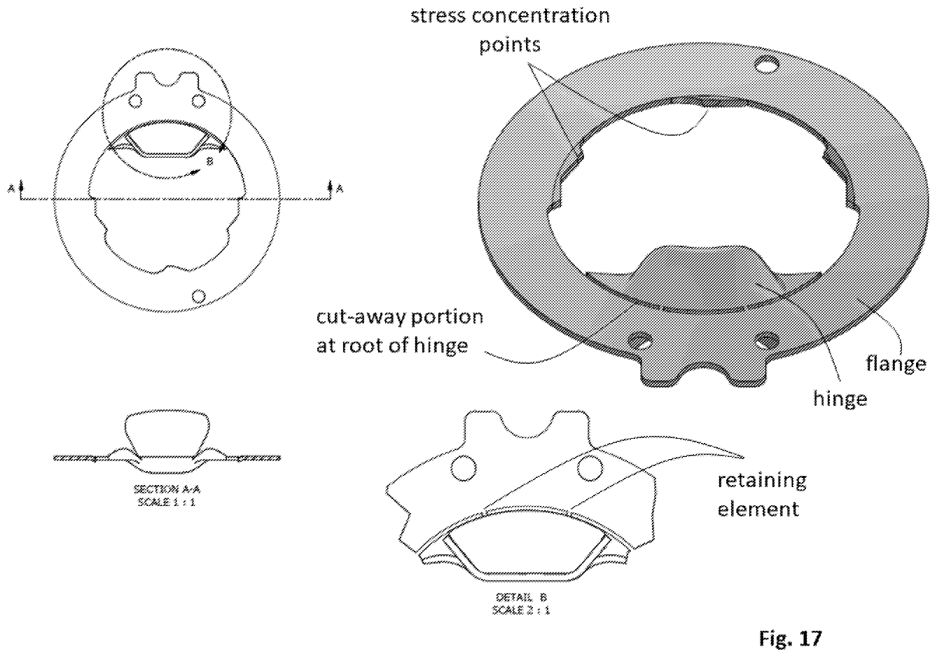

FIG. 17 illustrates another embodiment of a kinetic hinge device, which includes a ring-shaped flange portion configured to be installed within mated flanges of a rupture disk holder (safety head assembly) and/or within mated flanges of a piping system. The internal edge of the flange portion is provided with stress concentration points, which may be configured to impinge on a rupture disk (not shown) upon activation, thereby initiating the opening or tearing of the rupture disk. The kinetic hinge device is further provided with a hinge, which connects to the flange via two retaining elements (best shown in “Detail B”). The retaining elements may be created by cutting away material at the root of the hinge. Alternatively, one retaining element or more than two retaining elements may be provided, and the retaining elements may be created by other methods (e.g., scoring, shearing, stamping, or ablation). When the rupture disk activates and opens, the rupture disk petal will impact and wrap around the hinge, causing the hinge to bend at the retaining elements. As a result, the hinge and rupture disk petal will be allowed to move largely out of the path of escaping fluid, thereby improving fluid flow characteristics. At the same time, the hinge will prevent the rupture disk petal from fragmenting.

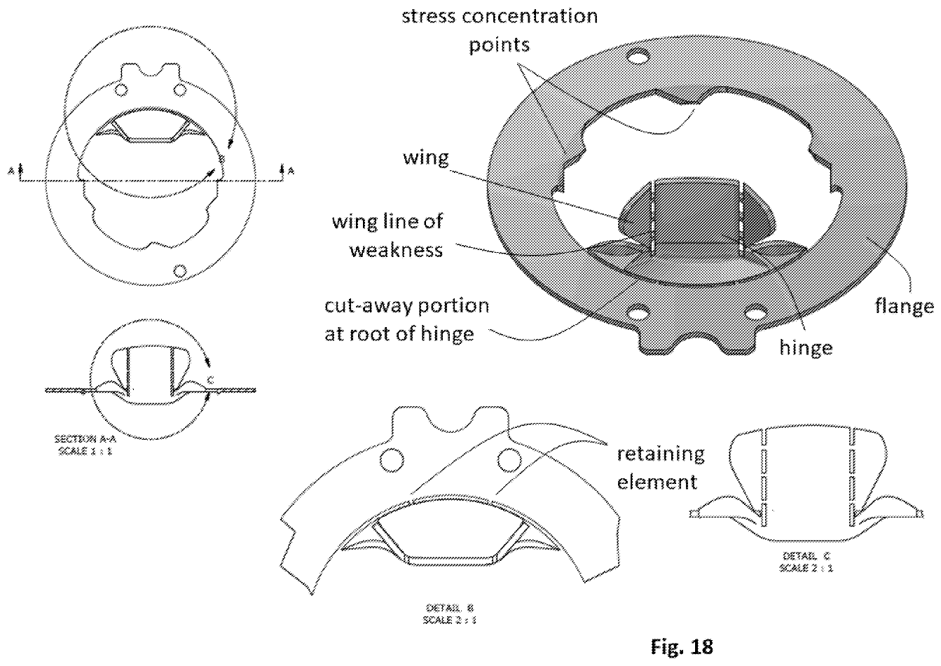

FIG. 18 illustrates another embodiment of a kinetic hinge device, which includes a ring-shaped flange portion configured to be installed within mated flanges of a rupture disk holder (safety head assembly) and/or within mated flanges of a piping system. The internal edge of the flange portion is provided with stress concentration points configured to initiate the opening or tearing of the rupture disk (not shown). The kinetic hinge device is further provided with a hinge, which connects to the flange via two retaining elements (best shown in “Detail B”). The retaining elements may be created by cutting away material at the root of the hinge. Alternatively, one retaining element or more than two retaining elements may be provided, and the retaining elements may be created by other methods (e.g., scoring, shearing, stamping, or ablation). As illustrated in FIG. 18, the hinge may be provided with additional or alternative deformable features, which may further improve the opening characteristics of the hinge. For example, FIG. 18 illustrates a configuration in which the hinge is provided with wings. Each wing may be provided with a line of weakness (e.g., the partially cut lines illustrated in FIG. 18) that may allow the wing to bend at the line of weakness. According to this design, when the rupture disk activates and opens, the rupture disk petal will impact and wrap around the hinge, causing the hinge to bend at the retaining elements and forcing the hinge wings into contact with the inner surface of the rupture disk holder. The hinge wings may then bend along their lines of weakness, absorbing kinetic energy and allowing the hinge body (and petal) to move further out of the path of fluid flow, until the leading edge/chord portion of the hinge body impacts the inner surface of the rupture disk holder.

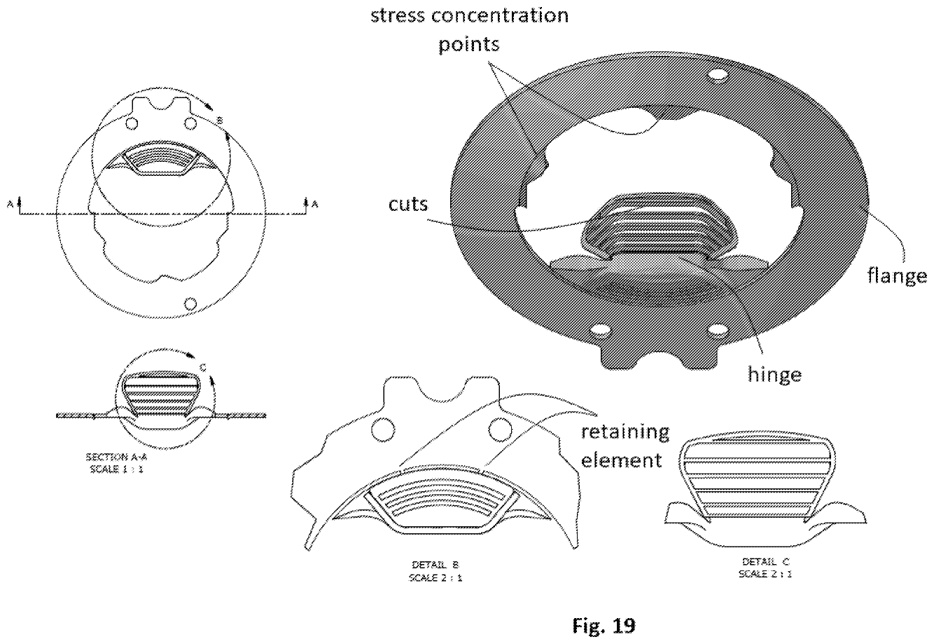

FIG. 19 illustrates another embodiment of a kinetic hinge device, which includes a ring-shaped flange portion configured to be installed within mated flanges of a rupture disk holder (safety head assembly) and/or within mated flanges of a piping system. The internal edge of the flange portion is provided with stress concentration points configured to initiate the opening or tearing of the rupture disk (not shown). The kinetic hinge device is further provided with a hinge, which connects to the flange via two retaining elements (best shown in “Detail B”). The retaining elements may be created by cutting away material at the root of the hinge. Alternatively, one retaining element or more than two retaining elements may be provided, and the retaining elements may be created by other methods (e.g., scoring, shearing, stamping, or ablation). As illustrated in FIG. 19, the body of the hinge may be provided with at least one cut, which may further improve the opening characteristics of the hinge. For example, FIG. 19 illustrates a configuration in which the hinge is provided with multiple cuts that may facilitate translation of the hinge in a radial direction (out of the path of flow) and may facilitate deformation/flattening of the hinge when brought into contact with the inner surface of the rupture disk holder. Although FIG. 19 illustrates cuts in a horizontal plane (e.g., parallel to the plane of the flange), it is contemplated that vertical cuts, oblique cuts, or a combination of cuts may be used to achieve optimal flow characteristics while retaining fragmentation control.

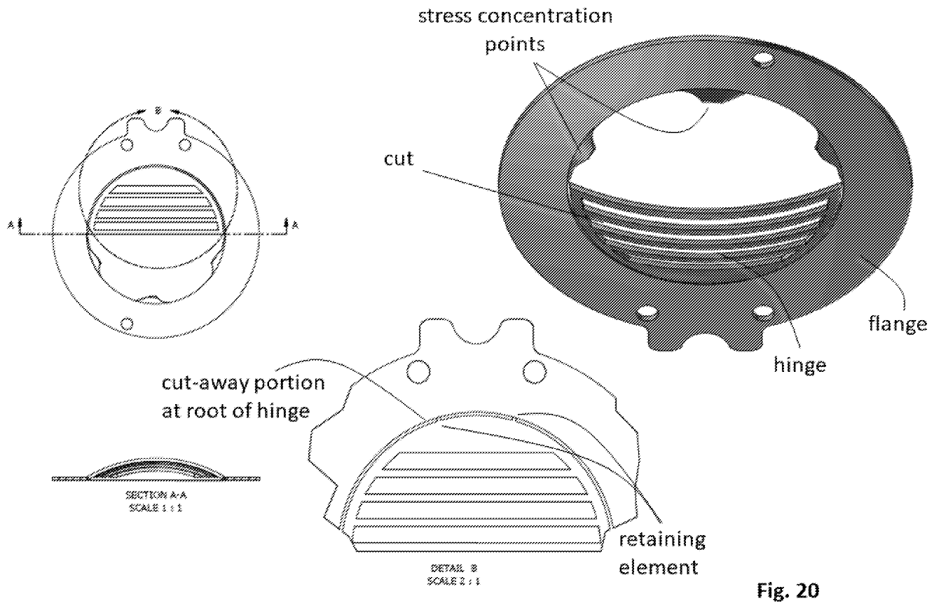

FIG. 20 illustrates another embodiment of a kinetic hinge. As illustrated, a kinetic hinge device includes a ring-shaped flange portion configured to be installed, e.g., within mated flanges of a rupture disk holder (safety head assembly) and/or within mated flanges of a piping system. The internal edge of the flange portion is provided with stress concentration points configured to initiate the opening or tearing of the rupture disk (not shown). The kinetic hinge device is further provided with a hinge, which connects to the flange via two retaining elements (best shown in “Detail B”). The retaining elements may be created by cutting away material at the root of the hinge. Alternatively, one retaining element or more than two retaining elements may be provided, and the retaining elements may be created by other methods (e.g., scoring, shearing, stamping, or ablation). As illustrated in FIG. 20, the body of the hinge may be provided with at least one cut, which may further improve the opening characteristics of the hinge. For example, FIG. 20 illustrates a configuration in which the hinge is provided with multiple cuts that may facilitate translation of the hinge in a radial direction (out of the path of flow) and may facilitate deformation/flattening of the hinge when brought into contact with the inner surface of the rupture disk holder. Although FIG. 20 illustrates cuts in a horizontal plane (e.g., parallel to the leading edge of the hinge), it is contemplated that vertical cuts, oblique cuts, or a combination of cuts may be used to achieve optimal flow characteristics while retaining fragmentation control.

The embodiments identified in FIGS. 17 to 20 each make use of at least one stress concentrating feature in the rupture disk hinge member to concentrate stress at its line(s) of weakness. The interaction between the kinetic hinge and the rupture disk may be achieved without such stress concentrating features present in the hinge member.

A further embodiment of a kinetic hinge may be achieved by constructing the hinge to be weak at its root location and robust at its initial engagement point with the rupture disk petal (e.g., the hinge's leading edge portion). In one embodiment, the hinge may be made robust at its leading edge/engagement point by folding or rolling hinge material over itself to create a reinforced/layered configuration. Alternatively, the leading edge of the hinge may be made robust through other means of reinforcement, such as forming the hinge into a ribbed geometry or providing a reinforcing component (such as a support bar) that may be joined (through welding, adhesives, or other means) at or near the leading edge of the hinge. Increasing the robustness of the leading edge/engagement point of the hinge may provide additional strength or stiffness where the hinge will engage with the petal. Other parts of the hinge, such as the root, may be left un-reinforced (e.g., with only a single layer of material or with fewer layers of material than the hinge leading edge), allowing for freedom of deformation or movement at the root to reduce the overall obstruction to flow. The robust section of the hinge may additionally be designed to connect with the inside diameter of the safety head outlet with the disk petal retained about it.

The above described embodiments of a kinetic hinge have been depicted in connection with a rupture disk; however, the disclosure is not intended to be limited to that type of pressure relief device. It is contemplated that a kinetic hinge may be used with other types of pressure relief device, such as burst panels, explosion vents, and deflagration vents, where there is a need to control the opening of the device and prevent fragmentation.

It is contemplated that individual features of one embodiment may be added to, or substituted for, individual features of another embodiment. Accordingly, it is within the scope of this disclosure to cover embodiments resulting from substitution and replacement of different features between different embodiments.

The above described embodiments and arrangements are intended only to be exemplary of contemplated mechanisms and methods. Other embodiments will be apparent to those skilled in the art from consideration of the specification and practice of the disclosure herein.

What is claimed is:

1. A hinge device for a rupture disk, the hinge assembly comprising:
a flange ring having an inner periphery defining a central fluid flow path;
a hinge extending from the inner periphery into the central fluid flow path, the hinge having a body, a root, and a leading edge; and
wherein the hinge is configured to deform in response to an activation of a rupture disk, thereby allowing the hinge to move radially out of the fluid flow path.

2. The hinge device of claim 1, wherein the hinge further comprises at least one retaining element joining the root to the inner periphery of the flange ring.

3. The hinge device of claim 2, wherein the retaining element is configured to bend in response to an activation of a rupture disk, thereby allowing the hinge to rotate or move radially out of the fluid flow path.

4. The hinge device of claim 1, wherein the leading edge of the hinge is reinforced.

5. The hinge device of claim 4, wherein the leading edge of the hinge is reinforced by folding or rolling hinge material over itself.

6. The hinge device of claim 4, wherein the leading edge of the hinge is provided with a stiffening element.

7. The hinge device of claim 1, further comprising:
a pre-weakened area between the body of the hinge and the flange ring;
wherein the hinge is further configured to deform at the pre-weakened area in response to an activation of a rupture disk, thereby allowing the hinge to move radially out of the fluid flow path.

8. The hinge device of claim 7, wherein the pre-weakened area comprises at least one perforation formed at the root of the hinge.

9. The hinge device of claim 1, further comprising:
at least one wing extending from the body of the hinge.

10. The hinge device of claim 9, wherein the at least one wing is configured to bend relative to the body of the hinge.

11. The hinge device of claim 1, further comprising:
an outlet support member defining a central bore and a support member flange, the support member flange engaged with the flange ring;
wherein the leading edge of the hinge is configured to impact the central bore of the outlet support member when the hinge rotates out of the fluid flow path.

12. The hinge device of claim 11, wherein the leading edge of the hinge forms a straight-chord geometry, and wherein the leading edge of the hinge is configured to retain a straight-chord geometry upon impact with the central bore of the outlet support member.

13. The hinge device of claim 11, further comprising:
an inlet support member; and
a rupture disk having a flange portion and a rupturable portion, the rupture disk further having an inlet side and an outlet side, the inlet side of the rupture disk flange portion being engaged with the inlet support member;
wherein the flange ring is engaged between the outlet support member and the outlet side of the rupture disk flange portion;
wherein the rupturable portion of the rupture disk is configured to open in response to a predetermined pressure; and
wherein the rupturable portion of the rupture disk is configured to wrap around the leading edge of the hinge after opening.
